(19) United States
(12) Patent Application Publication
(10) Pub. No.: US 2018/0160856 A1
(43) Pub. Date: Jun. 14, 2018

(54) Splash Protector for a Spindle Mixer or Similar Machine

(71) Applicant: Vita-Mix Management Corporation

(72) Inventor: Stephen Patrick Rukavina, Rocky River, OH (US)

(21) Appl. No.: 15/106,536

(22) PCT Filed: Feb. 18, 2015
(86) PCT No.: PCT/US2015/016265

§ 371 Date: Jun. 20, 2016

Related U.S. Application Data
(60) Provisional application No. 61/941,665, filed on Feb. 19, 2014.

(51) Int. Cl. A47J 43/07; A47J 31/44; A47J 43/042; A47J 43/044

(52) U.S. Cl. CPC A47J 43/0705; A47J 43/044; A47J 43/042; A47J 31/44

(57) ABSTRACT

A splash protector for a spindle mixer or similar machine is provided in order to minimize or eliminate unwanted splashing or spraying of foodstuff out of the mixing vessel during operation of the machine. The splash protector includes a splash guard mount part configured to be attached to the spindle mixer and a splash guard body removably attachable to the splash guard mount part such as by a user's hand, wherein the splash guard body is configured to be removed and attached to the splash guard mount part without the use of tools. Consequently, the splash protector can be readily removed for cleaning and readily reattached for additional use.

### FIELD

This technology relates to a splash protector, and more specifically, to a splash protector for a spindle mixer or similar machine.

### BACKGROUND

Spindle mixers and similar equipment often generate splash of foodstuff or the media they are mixing, most often due to the centrifugal force generated by the spinning agitator that is typical to this type of equipment. It is therefore desirable to provide a means of shielding the operator and the adjacent equipment and surfaces from this splash. It is also desirable to make the means of splash protection easy to remove for cleaning while still providing a secure attachment of the splash guarding device to the machine. Designs of the past requiring tools to remove the splash guard are not conducive to regular cleaning, and more often than not, a regular cleaning regime is not maintained due to the extra time required to un-fasten these types of splash protectors or splash guards.

Further, current splash guards are predominantly of the design that utilizes the hand, wrist or forearm of the hand of the operator that is holding the cup or receptacle of the item to be blended or processed to displace the front, movable portion of the splash protector (e.g. “splash shield”). One problem associated with these designs is the rough edge at the bottom of the splash shield and the discomfort that is often associated with displacing this type of splash shield.

### BRIEF DESCRIPTION OF THE DRAWING FIGURES

FIG. 1 is a perspective view of a first embodiment of a splash protector;

FIG. 2 is a cross-sectional view of the first embodiment of FIG. 1 taken at line 2-2;

FIG. 3 is a cross-sectional view of the first embodiment of FIG. 1 taken at line 3-3;

FIG. 4 is a partial cross-sectional view of a second embodiment of the splash protector; and

FIG. 5 is a partial cross-sectional view of a third embodiment of the splash protector.

### DETAILED DESCRIPTION

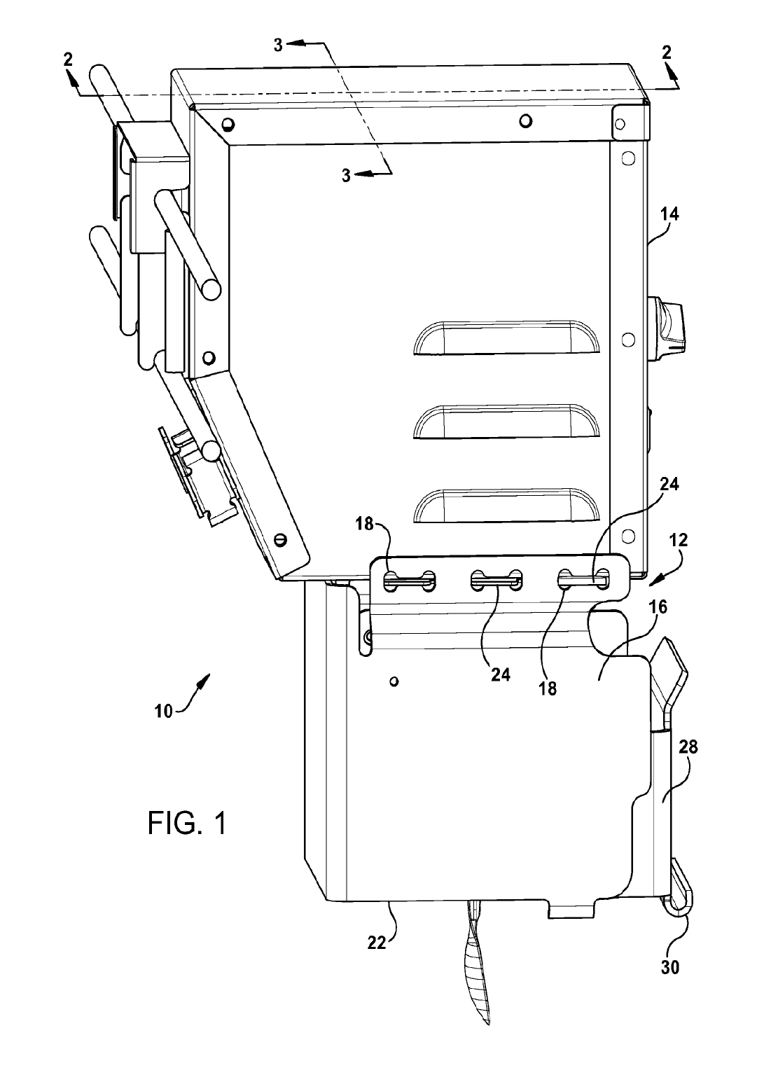

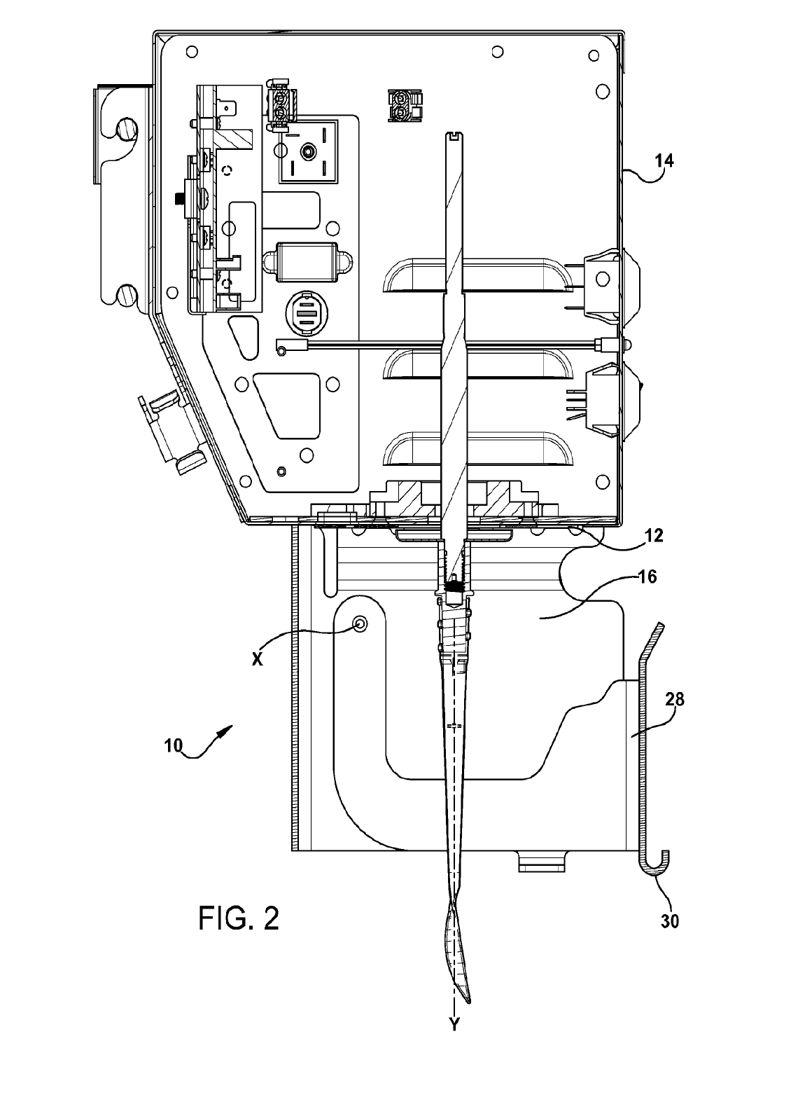

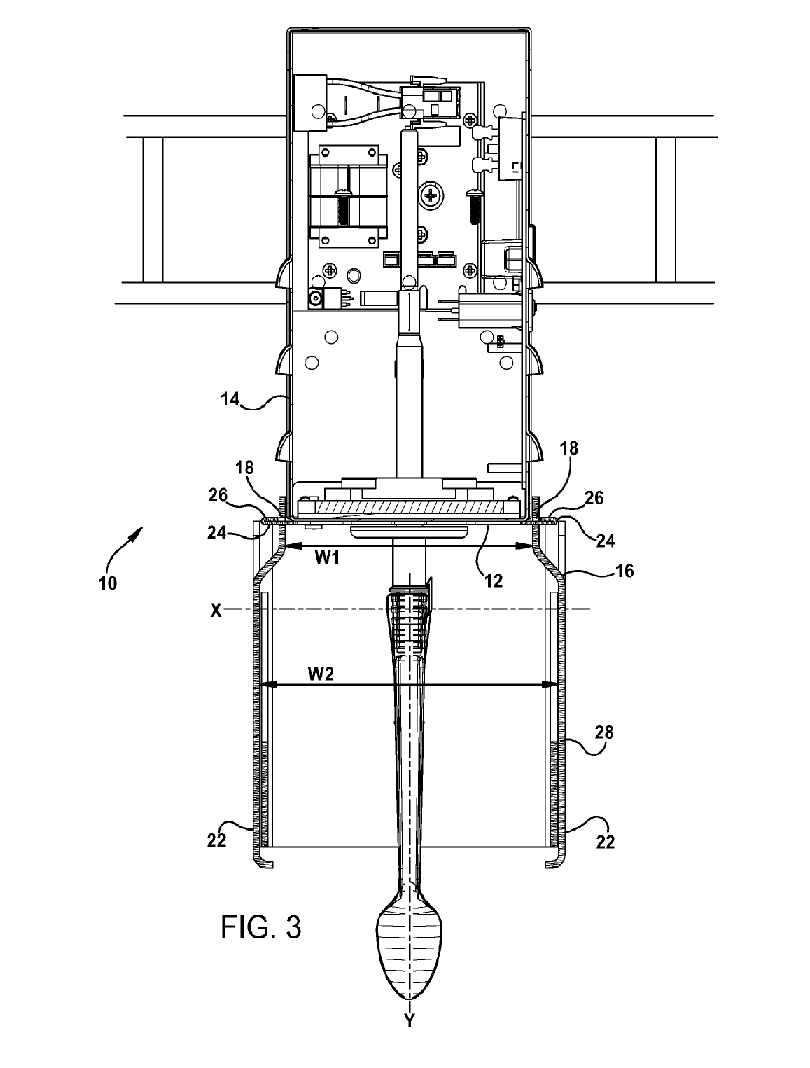

The present invention is a splash protector 10 comprising a splash guard mount part 12 that is mechanically attached to a spindle mixer 14 or like machine (via simple fasteners such as screws or other means familiar to those in the art) and a splash guard body 16 that is attached to the splash guard mount 12 via features that provide a secure attachment, yet allow for removal from the splash guard mount without the use of tools. FIGS. 1-3 show a first example embodiment of the splash protector 10 wherein the attachment of the splash guard body 16 to the splash guard mount 12 can be accomplished by means of horizontal slots 18 in two parallel, predominantly vertical sidewalls 22 of the splash guard body 16 that receive horizontal tabs 24 that protrude from the splash guard mount 12. The tabs 24 would support the weight of the splash guard body 16. In order to prevent accidental disengagement of the slots 18 with the tabs 24, the tabs 24 could employ one or more raised sections 26 that would require the user to consciously lift the splash guard body 16 so that the slots 18 could clear the raised sections 26. It should be appreciated that although the example embodiment comprises a plurality of slots 18 and tabs 18, there may be embodiments wherein only one slot and corresponding tab is provided. However, there may be any number of slots 18 and corresponding tabs 24 without departing from the scope of the invention. Moreover, although the slots 18 in the example embodiment are provided in the vertical sidewalls 22 of the splash guard body 16, they may be alternatively or additionally provided on the front or back walls of the splash guard body 16.

The vertical sidewalls 22 of the splash guard body 16 may be spaced apart at the uppermost portion of the splash guard body 16 by a first width (side to side or lateral) dimension W₁ that is preferably very close in size to the lateral dimension of the spindle mixer or machine itself. The first width dimension W₁ may be slightly smaller than or slightly larger than the lateral dimension of the spindle mixer or machine itself. The sidewalls 22 may extend downward at that dimension to a position corresponding vertically to the uppermost possible travel of the cup or vessel containing the item to be mixed or processed. The sidewalls 22 then “flare out” as the sidewalls 22 extend vertically below the position corresponding to the uppermost possible travel of the cup or vessel containing the item to be mixed or processed to a second width dimension W₂ that accommodates a wider range of motion to enable easier manipulation of the item to be processed. This transition of the sidewalls 22 from the first width dimension W₁ to the second width dimension W₂ enables close placement of adjacent equipment to the unit (ex. cup holders/lid holders/items to be processed/other processing equipment) while simultaneously accommodating a wide range of motion for the operator to better and more easily process the item to be processed.

The present invention is also characterized by a splash shield 28 that is rotatably attached to the splash guard body 16 about an axis X predominantly behind an axis Y of the spindle, and above the furthest most possible travel of the top of the vessel holding the material to be processed or blended. The splash shield 28 serves the purpose of providing splash protection for the operator by interposing itself directly between the operator and the item to be processed while still allowing the operator to manipulate the item to be processed freely.

The splash shield is further characterized by a front, lower edge 30 that is provided with a generous bearing surface for the operator's hand or wrist or arm to act upon in order to displace the splash shield while blending. This can be accomplished in several ways. For example, as shown in FIGS. 1 & 2, the lower edge 30 has a generously radiused return that provides a smooth and comfortable bearing surface for the user. However, in other embodiments, the lower edge 30 may include secondary pieces, overmolded pieces, or soft durometer materials to provide a generous bearing surface.

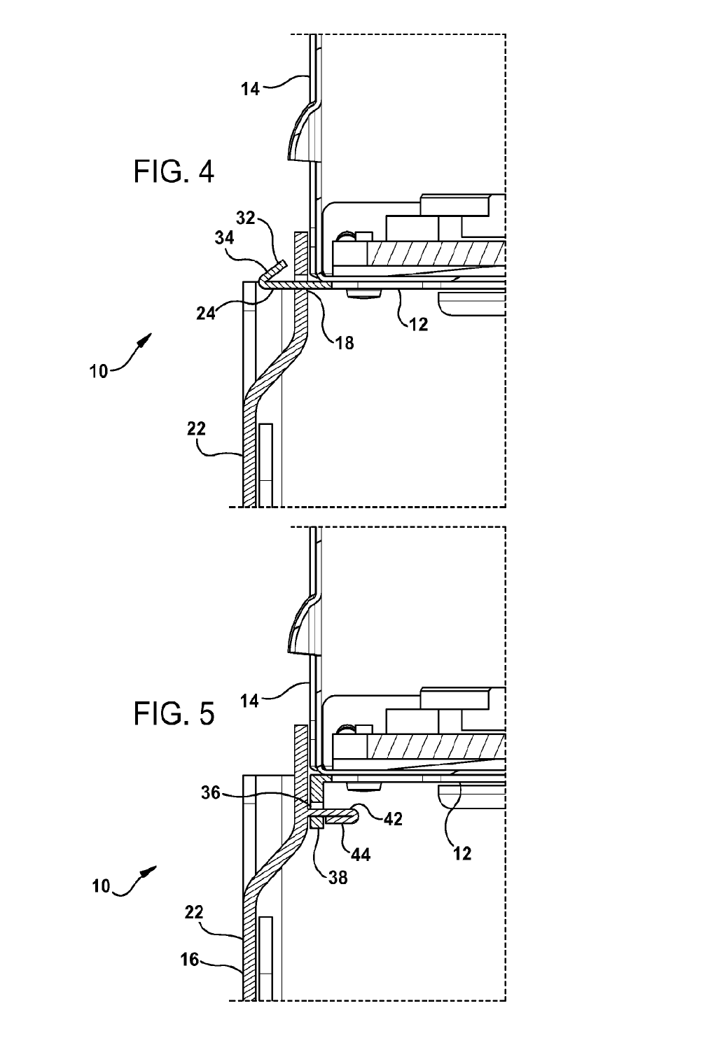

A second embodiment of the splash protector 10 is shown in FIG. 4 which also employs slots 18 in the splash guard body 16 with horizontal tabs 24 that protrude from the splash guard mount 12. The tabs 24 in this embodiment however employ flexible latches 32 with lead-in features 34 that would be received into the slots 18 in the splash guard body 16. As the flexible latches 32 pass through the slots 18 in the splash guard body 16, they would deflect until the lead in features 34 cleared the slots 18 completely, and the latches 32 would then spring back and catch the edges of the slot in the splash guard body 16. To remove the splash guard body 16, the latches 32 would be depressed by a user until they cleared the edges of the slots 18 in the splash guard body 16, which would then allow the removal of the splash guard body 16.

A third embodiment of the splash protector 10 is shown in FIG. 5. In this embodiment, the attachment of the splash guard body 16 to the splash guard mount 12 can be accomplished by means of horizontal slots 36 in two parallel, predominantly vertical sidewalls 38 of the splash guard mount 12 that receive horizontal tabs 42 that protrude from the splash guard body 16. In order to prevent accidental disengagement of the slots 36 with the tabs 42, the tabs 42 could employ one or more lowered sections 44 that would require the user to consciously lift the splash guard body 16 so that the lowered section 44 can feed through the slots 36.

According to the foregoing, the removal and re-attachment of the splash protector is readily performed manually by the user's hand or hands and without the use of tools. Therefore, the splash protector may be removed for cleaning or when not in use and then reattached in a tool-free manner.

What is claimed is:

1. A splash protector for a spindle mixer comprising:
a splash guard mount part configured to be attached to the spindle mixer;
a splash guard body removably attachable to the splash guard mount part,
wherein the splash guard body is configured to be removed and attached to the splash guard mount part without the use of tools; and
a splash shield rotatably attached to the splash guard body about an axis X predominantly behind an axis Y of a spindle to provide splash protection.

2. The splash protector of claim 1, wherein the splash guard body comprises one or more slots and the splash guard mount part comprises one or more corresponding tabs configured to be received within the one or more slots to removably attach the splash guard body to the splash guard mount part.

3. The splash protector of claim 2, wherein the one or more tabs each comprise a raised portion configured to require a user to lift the splash guard vertically to remove the splash guard body from the splash guard mount part.

4. The splash protector of claim 2, wherein the one or more tabs each comprise a flexible latch configured to releasably lock the splash guard body in an attached position when the one or more tabs are inserted into the corresponding one or more slots.

5. The splash protector of claim 4, wherein the flexible latch is depressed to remove the splash guard body from the splash guard mount part.

6. The splash protector of claim 1, wherein the splash guard mount part comprises one or more slots and the splash guard body comprises one or more corresponding tabs configured to be received within the one or more slots to removably attach the splash guard body to the splash guard mount part.

7. The splash protector of claim 6, wherein the one or more tabs each comprise a lowered portion configured to require a user to lift the splash guard vertically to remove the splash guard body from the splash guard mount part.

8. The splash protector of claim 1, further comprising a splash shield rotatably coupled to the splash guard body.

9. The splash protector of claim 8, wherein the splash shield comprises a lower edge that is rounded.

10. A splash protector for a spindle mixer comprising:
a splash guard mount part configured to be attached to the spindle mixer;
a splash guard body removably attachable to the splash guard mount part;
a splash shield rotatably attached to the splash guard body, wherein the splash shield is characterized by a front-facing, lower edge that includes a bearing surface for displacing the splash shield during an operation of the spindle mixer; and
means for removing and attaching the splash guard body to the splash guard mount without the use of tools.
